(19) United States
(12) Patent Application Publication
(10) Pub. No.: US 2012/0168265 A1
(43) Pub. Date: Jul. 5, 2012

(54) Hydraulic Accumulator System and Method for Operating a Hydraulic Accumulator System

(75) Inventor: Dirk Mahnkopf, Eglosheim (DE)

(73) Assignee: ROBERT BOSCH GMBH, Stuttgart (DE)

(21) Appl. No.: 13/386,427

(22) PCT Filed: May 26, 2010
(86) PCT No.: PCT/EP2010/057196

§ 371 Date: Mar. 24, 2012

(30) Foreign Application Priority Data
Jul. 24, 2009 (DE) 102009027998.9-21

(51) Int. Cl. B60T 8/26; B60T 13/58

(52) U.S. Cl. 188/106 P; 138/31

(57) ABSTRACT

A method and a device are disclosed which, as part of an overall brake system i.e. a brake system consisting of a conventional part and a further, for example recuperative part, can cause volume displacements in a brake circuit or in a piston-cylinder unit on a brake pedal. This is used in order to compensate for a change in the pressure conditions through the controllable servobrake in the hydraulic part of the brake system owing to an additional braking action of the further part of the brake system and thereby to blend braking actions of different brake systems to form an overall braking action without the driver realizing this at the brake pedal by changing the position of the pedal. The method can be used, for example, in vehicles in which a braking deceleration is caused by operating an electric machine as a generator to produce current and which additionally have a conventional, hydraulic brake system as a further brake system or backup brake system.

### PRIOR ART

In a hydraulic brake system of a motor vehicle, it is usually the case that a brake pedal is actuated by the driver, and, if appropriate with the assistance of a brake force booster, mechanically displaces a piston in a master brake cylinder, to the outlets of which a hydraulic unit is connected. As a result, brake fluid is introduced into the hydraulic unit (for example ESP or ABS) and conducted to the wheel brake cylinders. The volume introduced increases the brake pressure there and, by pressing the brake linings against the brake disks, leads to a braking action.

In vehicles in which an electric motor is provided for driving the motor vehicle, the electric motor can be utilized as a generator, for example in order to charge a battery, in driving situations in which the electric motor is not utilized as a drive. The operation of the electric motor as a generator leads to a braking action in which kinetic energy of the vehicle is converted into electrical energy; this is referred to as recuperative braking. The energy gained during a braking operation can be used again in some other way at a later time, for example for driving the vehicle.

The generator torque which the generator contributes to the braking operation is generally dependent on the driving speed of the motor vehicle and therefore varies during the braking operation, or the braking action generated by the generator is insufficient. To compensate or even supplement this changing generator torque, a recuperative brake system may be combined with a hydraulic brake system to form an overall brake system.

If the driver predefines a desired overall braking torque, for example by means of a brake pedal actuation, it is possible for the difference between the overall braking torque and the generator torque to be imparted by the hydraulic brake system, for example by means of an increase in pressure in the hydraulic brake system if the generator torque is too low in relation to the overall braking torque desired by the driver. A change in pressure, for example as a result of a change in the action of the brake force booster in the hydraulic brake system, in conventional brake systems usually leads to a change in the actuating travel of the brake pedal, which is irritating for the driver.

Therefore, the brake pedal is often connected to a pedal travel simulator for generating a pedal feel for the driver, and the brake pedal is completely decoupled from the brake system, and the pressure build-up in the hydraulic brake system is generated entirely by external force, for example from an accumulator. This however harbors the risk that, in the event of failure of the external force, mechanical coupling can no longer be provided between the brake pedal and the wheel brake, and there is therefore no possibility of emergency actuation by the driver alone.

WO 2004/101308 discloses a method for how pressure conditions in a hydraulic brake system can be changed in order to operate the hydraulic brake system together with a regenerative brake system, and to obtain a high level of braking comfort here. For this purpose, in said document, volumes of brake medium are discharged into a low-pressure accumulator. Said brake medium can be supplied from this low-pressure accumulator back to the hydraulic brake circuit again by means of the actuation of a pump.

### DISCLOSURE OF THE INVENTION

By means of the device according to the invention having the features of claim 1 and the method according to the invention having the features of claim 6, it is possible for a generator torque from a recuperative part of an overall brake system to be combined with a braking torque of a hydraulic brake system, while eliminating changes, which are irritating for the driver, in the position of the brake pedal for a given driver input force. Furthermore, in an emergency situation, there remains a fall-back level as a result of the fact that there is still coupling between the brake pedal and the hydraulic brake system.

For this purpose, a hydraulic accumulator device is connected to a hydraulic brake system which, together with a further, non-hydraulic brake system, forms an overall brake system. The hydraulic accumulator device is connected to the master cylinder and to at least one wheel brake which is connected in the hydraulic brake system.

The crux of the invention is that the hydraulic accumulator device admits volume from the hydraulic brake system, holds volume or automatically discharges volume into the hydraulic brake system, as a function of the operating state of the further brake system. As a result of the admission of volume and/or discharging of volume from or into the hydraulic brake system, a change, as mentioned in the introduction, of the pedal position of the brake pedal can be counteracted. As a result of the automatic discharging, a volume delivery device—in particular an additional volume delivery device—such as for example a return feed pump, for emptying the accumulator is made superfluous, which leads to a cost-effective embodiment.

In one advantageous embodiment, said operating state of the further brake system is represented by a change in the contribution made by the further brake system to the overall braking action. In particular, the hydraulic accumulator device is operated such that
admission of volume takes place if the contribution made by the further brake system is increased, and/or
discharging of volume takes place if the contribution made by the further brake system is reduced.

In one advantageous embodiment, the hydraulic accumulator device has at least one piston, at least one cylinder and at least one elastic element. Likewise conceivable is a hydraulic accumulator device in the form of a diaphragm accumulator and/or a metal bellows-type accumulator, and any further volume accommodating unit with accumulator function.

Also provided are means for shutting off a hydraulic connection, by which means the hydraulic accumulator device can be decoupled from the wheel brakes in the hydraulic brake system. Said shut-off means are controlled such that either
volume can be or is admitted, or
volume can be or is held, or
volume can be or is discharged,
   by means of the hydraulic accumulator device.

In particular, the brake system may have an actuating element for the brake system, which actuating element has a piston-cylinder unit which is likewise connected to the hydraulic accumulator device. Said hydraulic connection, too, can be shut off by further shut-off means. By said further shut-off means, the hydraulic accumulator device can be emptied in the direction of the piston-cylinder unit integrated into the actuating element.

Furthermore, the respective cross-sectional areas of the at least one cylinder of the hydraulic accumulator, of the cylinder of the piston-cylinder unit and of the master cylinder must be selected carefully such that a transport of volume in the hydraulic brake system in relation to the hydraulic accumulator owing to the resulting pressure conditions is also possible. For this purpose, consideration must also be given to the preload and the design of the at least one elastic element, and likewise to the possibly already prevailing pressure level in the hydraulic accumulator device.

It is provided in the method according to the invention that a hydraulic accumulator device is operated as a function of an operating state of the further brake system so as to admit volume of brake fluid from the hydraulic brake system, hold volume and discharge volume back into said hydraulic brake system, in particular as a function of the change in braking torque of the further brake system.

Furthermore, the operating state of the further brake system may be represented by a change in the contribution made by the further brake system to the overall braking action. If the contribution made by the further brake system to the overall braking action increases, the hydraulic accumulator device admits volume, whereas if the contribution decreases, the hydraulic accumulator device discharges volume.

In a further refinement, the hydraulic brake system has a brake force booster which boosts the brake force imparted by the driver. Said brake force booster is actuated so as to generate—in combination with the further brake system—an overall braking action. If the contribution made by the further brake system increases, the action of the brake force booster is reduced, whereas if the contribution made by the further brake system decreases, the action of the brake force booster is increased. A displacement of the brake pedal arising as a result of said actuation of the brake force booster is counteracted by actuation, according to the invention, of the hydraulic accumulator device, in particular by virtue of volume being admitted and/or discharged from and/or into the hydraulic brake system. The pedal displacement is entirely and/or at least partially compensated.

Furthermore, controllable shut-off means are provided which shut off the at least one hydraulic connection between the hydraulic accumulator device and the hydraulic brake system, and by means of the activation of which the discharging of volume and/or the admission of volume of brake fluid into and/or from the hydraulic brake system and the accumulation of the volume of brake fluid is controlled.

Further shut-off means are advantageously provided which hydraulically decouple the wheel brakes, which are connected to the hydraulic brake system, from the hydraulic accumulator device and from the master cylinder. By means of the controllable brake force booster provided in the hydraulic brake system, it is possible, with the wheel brakes decoupled from the hydraulic brake system, for the hydraulic accumulator device to be charged by actuating the controllable brake force booster.

It is provided in particular that, to increase the pressure level at which volume can be discharged from the accumulator, said accumulator is pre-charged, such that it is possible for volume to be re-introduced from the accumulator into the hydraulic brake system or into the piston-cylinder unit at a higher pressure level. This may likewise be made possible by means of the structural design of the hydraulic accumulator device.

In one advantageous refinement of the method, the accumulator is pre-charged in driving situations in which the driver is not braking.

### DESCRIPTION OF THE DRAWINGS

FIG. 1a shows the device according to the invention integrated into a hydraulic brake system, and a further exemplary embodiment as an insert in FIG. 1b (highlighted in gray).

FIG. 2 shows three method steps by which the travel compensation at the pedal is carried out upon the activation of a generator torque.

FIG. 3 shows three method steps by which the travel compensation at the pedal is carried out upon the deactivation of a generator torque.

FIG. 4 shows a further embodiment of the device according to the invention in which the accumulator unit has two chambers, but, in contrast to FIG. 1, the accumulator is emptied into the hydraulic brake system and not into the input chamber.

FIG. 5 shows a further embodiment similar to FIG. 4, but with only one chamber.

### EMBODIMENTS OF THE INVENTION

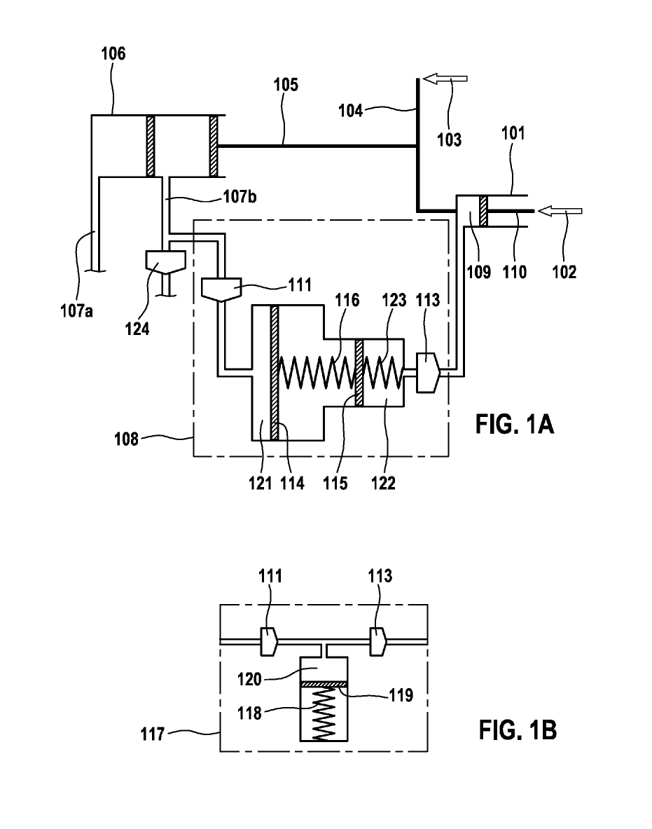

A preferred embodiment is based on an overall brake system which is composed of a conventional hydraulic part (comprising for example ESP, ABS components) and an additional part. For the purposes of this example, it is assumed that the additional contribution to the braking action is made by a recuperative brake system and is imparted by a generator torque. The conventional part of the brake system is composed of an input device 101 by means of which a driver force 102 can be introduced into the brake system. Said driver force may be combined with an assistance force, originating for example from a controllable brake force booster, at a coupling element 104, for example at a reaction plate. Said controllable brake force booster may be either an electromechanical or a controllable vacuum-type brake force booster with for example electrically switched valves, though further embodiments are also conceivable. The coupling element 104 is mechanically connected 105 to the input rod of a master cylinder 106 of the brake system, shown in FIG. 1 as a tandem master cylinder 106 but not restricted to this embodiment of a master cylinder. The master cylinder 106 has two outlets 107 a, b for brake fluid, which outlets lead in each case to at least one brake circuit of the brake system and therefore connect wheel brakes (not shown), which are connected to the brake circuit, hydraulically to the master cylinder 106. Said hydraulic connection between the master cylinder 106 and wheel brake can be shut off by means of a controllable valve 124. In conventional return feed systems, the valve 124 may be provided for example in the form of inlet valves of a hydraulic unit, for example of the switching valves. There is no significant difference in relation to a conventional brake system up to this point. An input force, coupled with a possible assistance force, transmits a braking demand of the driver by means of a pressure change in a master cylinder into a hydraulic brake system.

If an additional braking torque is now to be blended in, a device is required by means of which the brake pressure in at least one brake circuit is adapted. This can be ensured by adapting the assistance force originating from the controllable brake force booster. As a result of this, however, the pressure in the hydraulic brake system changes and therefore the admitted volume changes, as a result of which the actuating unit is displaced.

To prevent this, the change in the brake pedal travel must be counteracted.

For this purpose, at least one of the outlets 107 a, b is hydraulically connected to a further component 108, which is additionally hydraulically connected to an input chamber 109 containing a piston 110.

The input chamber 109 and piston 110 are structurally integrated into the input device 101. The accumulator unit 108 is composed of two switching valves 111, 113 and a piston-cylinder unit composed of two pistons 114, 115 and two chambers 121, 122 of different cross-sectional area, wherein the pistons are coupled by means of a preloaded spring 116. Furthermore, the piston 115 is connected by means of a compression spring 123 to the housing of the right-hand chamber 122 of the hydraulic accumulator. The chamber with the larger cross-sectional area can be separated from the brake circuit by valve 111, and the chamber with the smaller cross section can be separated from the input chamber 109 by valve 113. Conventional operation of the hydraulic brake system is possible by virtue of the valves 111 and 113 being held closed, or valve 111 being held closed and the piston 109 being situated against the stop, wherein valve 113 may then be open.

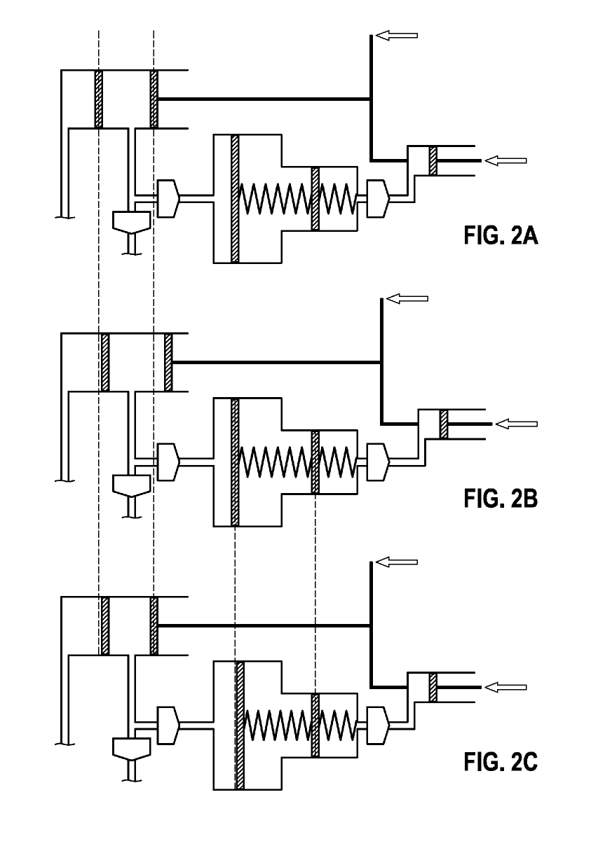

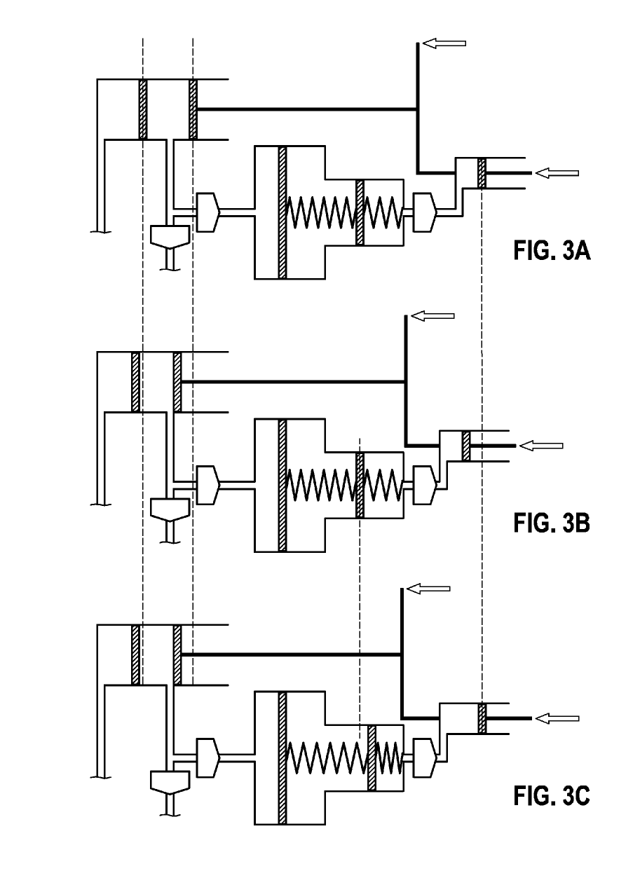

The method according to the invention shall be explained on the basis of two typical operating situations of the overall brake system. For this purpose, a design according to the above-described first embodiment will be used as a basis.
Situation 1: driver brakes, a generator torque is activated or increases (FIG. 2)
Situation 2: driver and generator torque provide braking, generator torque is deactivated or decreases (FIG. 3).

The terminology corresponds to that used for the above figures.

It is clear that the device according to the invention and the method according to the invention have an effect not only upon the activation and deactivation of a generator torque, but rather also in the event of a change in the contribution made by the generator torque.

FIG. 2a schematically illustrates how, in a first step, a driver, on the basis of a braking demand, introduces a driver force into the brake system by virtue of the input device 101 being displaced by the driver. The driver performs purely conventional braking. An assistance force from the controllable brake force booster additionally acts on the coupling element. As described above, in this braking situation, the valves 111 and 113 are closed, or valve 111 is closed and the piston 109 is situated against the stop, wherein valve 113 may then be open.

A generator torque is now activated, which causes intensified deceleration of the vehicle. Now, the driver is braking conventionally and recuperatively at the same time.

To ensure a constant deceleration, the assistance force from the regulable brake force booster is reduced, as illustrated in FIG. 2b. As a result, the pressure in the brake system is reduced, and brake medium flows back into the master cylinder. The piston of the master cylinder, and owing to the mechanical connection to the coupling element also the input device 101, are thereby offset oppositely to the original actuating direction. To compensate this offset, the valve 111 is opened, and brake fluid is discharged from the brake circuit into the accumulator. For this purpose, the valve 113 is held closed.

As a result, the input device 101 is displaced in the direction of the original actuating direction again. The difference in travel of the input device owing to the activation of a generator torque is thereby entirely, or at least partially, compensated by the discharging of brake medium into the accumulator device.

FIG. 3 takes as a basis the fact that the driver is already braking with a combination of conventional and recuperative brake systems. The situation in FIG. 3a corresponds to that in FIG. 2c. The input device 101 is situated at a fixed actuating travel. If the generator torque is deactivated, the controllable brake force booster must impart a greater assistance force in order to ensure a constant braking deceleration expected by the driver on the basis of his pedal position. A greater assistance force results in a higher pressure in the master cylinder, a corresponding volume of brake medium is displaced into the brake circuits, and the pistons, and therefore also the input device 101, are displaced in the direction of the assistance force. Here, too, to again compensate this displacement, volume is discharged out of the right-hand chamber of the accumulator into the input chamber 109 in the input device 101 by opening the valve 113, the piston 110 is thereby displaced in the direction of the driver, and therefore the travel difference of the input device owing to a reduction in the generator torque is entirely or at least partially compensated.

After the end of a braking process, the valves 111 and 113 can be opened, and the accumulator can pass into the starting state again—if appropriate with assistance from the action of the springs 116 and 123. For this purpose, the right-hand chamber 122 admits brake fluid from the input element, and the left-hand chamber 121 discharges brake fluid to the brake circuit or to the storage tank of the master cylinder. An alternative possibility (not shown here) for supplying brake fluid back to the system again is by means of a direct hydraulic connection, which can be shut off, from each of the two chambers to at least one storage tank with brake fluid, in particular the storage tank of the master cylinder.

By means of the described embodiment of the accumulator unit composed of two chambers, the pressure level is raised. For example, if the cross section of the right-hand piston is only one-third the size of the cross section of the left-hand piston, and if the preload of the spring 116 is configured such that a pressure of 5 bar prevails in the left-hand chamber, then brake fluid can be extracted from the right-hand chamber at a pressure of at least 15 bar, but in a volume only one-third of that previously discharged into the left-hand chamber.

The preload of the spring may be realized for example by means of a binding of the two pistons or by means of a discharge of brake fluid into the accumulator and resulting stressing of the spring.

Furthermore, use is made of the fact that the force on the input piston 110 is lower than the force in the master cylinder.

In addition to the approach discussed just above for operating the hydraulic accumulator, the latter may be pre-charged. In the method according to the invention, this is realized by operating the brake force booster such that the latter exerts a force on the master cylinder piston 105 and therefore volume is displaced in the direction of the at least one connected brake circuit and of the hydraulic accumulator. To supply the volume of brake fluid to the hydraulic accumulator, more specifically to the left-hand chamber thereof, the valve 111 is opened and the valve 113 is closed.

Furthermore, the hydraulic connections to the wheel brakes are shut off by means of the valve 124 in order to prevent a braking action during a pre-charging of the hydraulic accumulator. In conventional return feed systems, this is realized by closing inlet valves of the hydraulic unit, for example the switching valves. By means of such pre-charging, it is possible to utilize more brake fluid from the right-hand chamber at a higher pressure level owing to the smaller cross-sectional area, as a result of which the field of application is broadened. A preload of the spring 116 is likewise generated by means of the pre-charging with the brake force booster.

An alternative refinement of the device according to the invention is illustrated 117 as an insert in FIG. 1. In the combination of two valves and the two-part piston-cylinder unit 108 from the first embodiment (FIG. 1), the piston-cylinder unit with two chambers 114, 115, 121, 122 is replaced by a piston-cylinder unit as an accumulator which has only one chamber 120. The piston-cylinder unit comprises a compression spring 118 and a piston 119. All other components remain identical 111, 113.

The applied method is the same as that in the embodiment just described with two coupled accumulator chambers.

By way of an example, it is assumed that the boost factor of the brake force booster is 5, the cross-sectional area of the chamber 120 is identical to that of the master cylinder, and the cross-sectional area of the input chamber 109 is 0.75 times the cross-sectional area of the master cylinder. The preload of the spring 118 in the accumulator chamber 120 is configured such that the pressure in the chamber is 5 bar; the stiffness of the spring can be neglected. The pressure in the brake system is 20 bar before the generator torque is blended in. With a master cylinder diameter of 25.4 mm, the force on the master cylinder is 1013 N, and that fraction of the force on the master cylinder which is imparted by the driver is 1013/(5+1)=168 N. If the fluid is discharged into the input chamber, it is possible, with 5 bar and a cross-sectional area of the input chamber of 0.75 times the cross-sectional area of the master cylinder, for a driver input force of 190 N to be overcome. Since the cross-sectional area of the input piston 110 is smaller than the cross-sectional area of the master cylinder, it is ensured that the travel generated by the discharging of brake fluid from the hydraulic accumulator into the input chamber is greater than the travel compensated by the discharging of brake fluid from the brake circuit. Owing to the similarity of the method to that already discussed above on the basis of FIGS. 2 and 3, a more detailed description will not be given.

Similarly to the discussion with regard to the hydraulic accumulator with two cylinders, it is possible in the embodiment with only one cylinder for the hydraulic accumulator to be pre-charged by actuating the brake force booster and opening the valve 111, shutting off the hydraulic connection to the wheel brakes by closing the valve 124, and closing the valve 113.

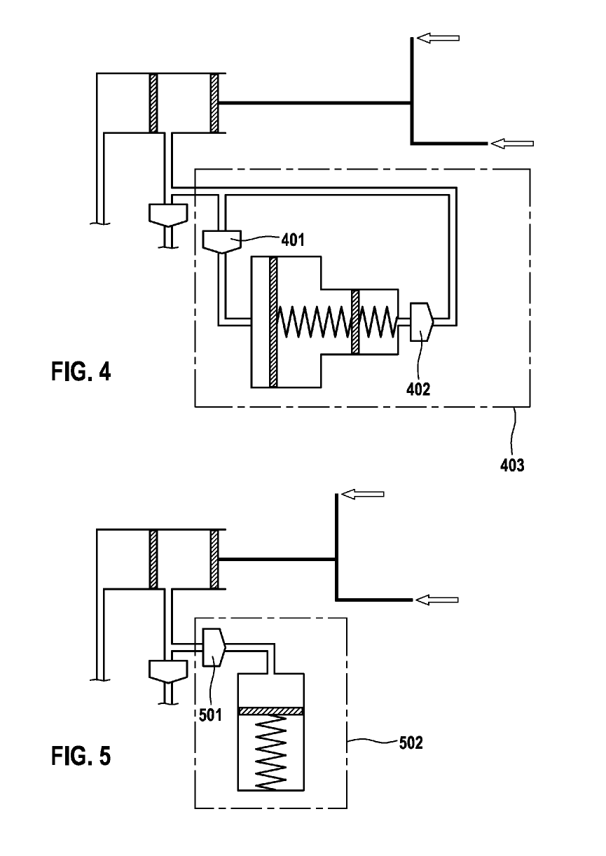

An alternative refinement of the device 403 according to the invention is illustrated in FIG. 4. The designation of the elements in this figure is the same as in FIG. 1. In this embodiment, in contrast to FIG. 1, the hydraulic accumulator is not emptied into an input chamber 109, but rather the volume is supplied back to the brake system at a higher pressure than that with which it was originally admitted into the accumulator. For this reason, a hydraulic link between the accumulator unit and a piston in the input element is not provided. With this embodiment, too, it is possible for a change in the position of the actuating element upon the activation or increase of a generator braking torque, and therefore in the event of a reduced assistance force of the brake force booster, to be at least partially compensated by virtue of brake fluid being discharged into the left-hand low-pressure chamber of the two-chamber accumulator by opening the valve 401, similarly to the method described above.

If the generator torque is deactivated or reduced, the assistance force must be increased again in order to obtain a constant braking deceleration. Here, to at least partially compensate a pedal displacement, fluid is supplied from the pressure accumulator to the brake circuit by opening the valve 402, and said fluid thus serves to provide the volume equalization necessary for the compensation.

Owing to the similarity of the method to that already discussed above on the basis of FIGS. 2 and 3, a more detailed description will not be given.

After a braking process, the accumulator is set into its starting state by virtue of the valves 401 and 402 being opened and the filling level of the chambers being restored to the filling level present before the braking operation—if appropriate with assistance from the action of the springs 116 and 123. In contrast to FIG. 1, the right-hand chamber 122 in this case admits fluid from the brake circuit and/or from the master cylinder. Here, too, an alternative possibility (not shown here) for supplying brake fluid back to the system again is via a direct hydraulic connection, which can be shut off, from each of the two chambers to at least one storage tank with brake fluid, in particular to the storage tank of the master cylinder.

To ensure complete compensation of the displacement of the actuating element—similarly to the discussion with regard to the hydraulic accumulator from FIG. 1—the hydraulic accumulator in FIG. 4 is pre-charged by actuating the brake force booster with the valve 402 closed and the valve 401 open and with the hydraulic connection to the connected wheel brakes shut off by the valve 124.

An alternative refinement of the device 502 according to the invention is illustrated in FIG. 5. In this situation, too, the accumulator variant with only one chamber is used. Here, too, as in FIG. 4, the hydraulic connection to the input element is dispensed with. The other components correspond to those from FIG. 1, and therefore need not be indicated once again.

In principle, upon the activation of a generator torque, volume can be admitted from the brake circuit into the accumulator with the valve 501 open, and, upon the deactivation of the generator torque, the volume can be discharged from the accumulator into the brake circuit. In this way, a displacement of the position of the input device 101 owing to a change in the assistance force from the brake force booster is counteracted. Owing to the similarity of the method to that already discussed above on the basis of FIGS. 2 and 3, a more detailed description need not be given. Similarly to the discussion with regard to the hydraulic accumulator in FIG. 1, it is possible in this embodiment for the hydraulic accumulator to be pre-charged by actuating the brake force booster and opening the valve 111 and shutting off the hydraulic connection to the wheel brakes by means of the valve 124, such that volume can be discharged at relatively high pressure into the brake circuit.

The dimensioning of the cross-sectional area(s) of the master cylinder 106, of the piston-cylinder unit 109 and 110 and of the chamber(s) of the hydraulic accumulator 108, 117, 403 and 502, and also the preload and design of the springs 116, 118 and 123, should be selected such that, depending on the prevailing pressure level, for example in the brake circuit, master cylinder or input chamber, a flow of brake medium from there from the accumulator or into the accumulator by opening valves for travel compensation is possible within design-based limits. In particular, the magnitude of the travel that can be compensated can also be set by means of such dimensioning. Here, the filling level of the accumulator should be taken into consideration; more precisely, said accumulator can admit brake fluid only until it has reached its maximum filling level, or can discharge brake fluid only until it is completely empty.

In all the embodiments shown, the quantity of brake fluid that is extracted from the brake system or supplied to the brake system or to the input chamber is regulated by activating the valves. Self-evidently under the assumption that, as described above, the pressure levels of the hydraulic components involved permit transportation of a volume. To control the volume exchange, the valves 111, 113, 401, 402 and 501 are connected to a control unit (not shown). Said control unit may for example already be provided in the brake system in the form of the control unit of the hydraulic unit or of the brake force booster.

For all of the embodiments discussed above, the description of the hydraulic accumulator as a combination of a piston-cylinder unit with spring and valves should in no way be understood as being restrictive. Also conceivable, inter alia, are a diaphragm accumulator and/or a metal bellows-type accumulator and/or a further volume accommodating unit with accumulator function.

Here, the description of the hydraulic accumulator is restricted to an accumulator which is connected to only one brake circuit, but the method and the device are not restricted to a number of connected brake circuits. Furthermore, the position of the valves connected in a further brake circuit may play a role, for example input valves of a further brake circuit connected to the master cylinder may play a role during the charging of the hydraulic accumulator in order to prevent a braking action as a result of the charging.

Instead of pre-charging the accumulator by means of the controllable brake force booster, said pre-charging may also be effected by means of some other type of volume delivery unit, for example a return feed pump of an ESP hydraulic unit, which is—if appropriate additionally—hydraulically connected to the brake circuit and/or to the master cylinder and/or directly to the accumulator. Depending on the design and positioning of the volume delivery unit in the brake system, it is necessary if appropriate to take into consideration the valve position of the valves situated in the hydraulic connection between the volume delivery unit and the hydraulic accumulator.

In summary, it can be stated that the invention describes a method and a device which, as part of an overall brake system composed of a conventional part and of a further, for example recuperative part, can effect volume displacements in a brake circuit or in a piston-cylinder unit at a brake pedal.

This is utilized to compensate a change in the pressure conditions effected by the controllable brake force booster in the hydraulic part of the brake system owing to an additional braking action of the further part of the brake system, and to thereby blend braking actions of different brake systems into one overall braking action, without this being perceptible to the driver at the brake pedal owing to a change in position of the pedal. The method may be used for example in vehicles in which a braking deceleration is caused by the operation of an electric machine as a generator for power generation, and which additionally have a conventional hydraulic brake system as a further brake system or backup brake system.

1-12. (canceled)

13. A hydraulic accumulator device for use in a hydraulic brake system of an overall brake system which, aside from the hydraulic brake system, comprises at least one further, non-hydraulic brake system, wherein the hydraulic brake system has a master cylinder and at least one wheel brake, wherein the hydraulic accumulator device is hydraulically connected to an outlet of the master cylinder and to the at least one wheel brake and, as a function of the operating state of the further brake system, either admits volume from the hydraulic brake system, holds volume or automatically discharges volume into said hydraulic brake system, wherein the hydraulic accumulator device has a first piston-cylinder unit which includes two pistons and two chambers of different cross-sectional area.

14. The hydraulic accumulator device as claimed in claim 13, wherein the operating state of the further brake system is represented by a change in the contribution made by the further brake system to the overall braking action, wherein it is provided that:
admission of volume takes place if the contribution made by the further brake system is increased, and/or
discharging of volume takes place if the contribution made by the further brake system is reduced.

15. The hydraulic accumulator device as claimed in claim 13, wherein the hydraulic accumulator device has at least one elastic element.

16. The hydraulic accumulator device as claimed in claim 13, wherein:
the hydraulic brake system has a shut-off mechanism configured to shut off a hydraulic connection between the hydraulic accumulator device, the master cylinder and the at least one wheel brake such that the at least one wheel brake is hydraulically decoupled from the hydraulic accumulator device and the master cylinder, and
the admission of volume from the hydraulic brake system, the accumulation of volume and the discharging of volume into the hydraulic brake system is realized by controlling the shut-off mechanism.

17. The hydraulic accumulator device as claimed in claim 13, further comprising a controllable shut-off mechanism, wherein:
the hydraulic brake system has an actuating element for the brake system and the actuating element has a second piston-cylinder unit which is hydraulically connected to the hydraulic accumulator device, and the controllable shut-off mechanism is configured to shut off the hydraulic connection between the hydraulic accumulator device and the second piston-cylinder unit, and
the admission of volume from the hydraulic brake system, the accumulation of volume and the discharging of volume into the hydraulic brake system is realized by controlling the controllable shut-off mechanism.

18. The hydraulic accumulator device as claimed in claim 15, wherein:
the respective cross-sectional areas of the chambers of the hydraulic accumulator device and of the master cylinder and/or
the preload and design of the at least one elastic element and/or
the charging state of the hydraulic accumulator device in relation to the pressure set in the hydraulic brake system
are dimensioned such that automatic discharging and/or accumulation of volume of brake fluid is achieved within design-based limits.

19. The hydraulic accumulator device as claimed in claim 18, wherein the cross-sectional area of the cylinder of the second piston-cylinder unit is dimensioned such that an automatic discharging and/or accumulation of volume of brake fluid is achieved within design-based limits.

20. A method for operating a hydraulic accumulator device in a hydraulic brake system of an overall brake system which, aside from the hydraulic brake system, comprises at least one further, non-hydraulic brake system, wherein the hydraulic brake system has a master cylinder and at least one wheel brake, wherein the hydraulic accumulator device, which is hydraulically connected to the at least one outlet of the master cylinder and to the at least one wheel brake, admits volume from the hydraulic brake system, holds volume or automatically discharges volume into said hydraulic brake system, as a function of the operating state of the further brake system, wherein the hydraulic brake system has a brake force booster which acts so as to boost the brake force imparted by the driver by an assistance force, and also an actuating element for the brake system, wherein the brake force booster is operated such that,
in the event of an increase in braking torque caused by the further brake system, the action of the brake force booster is reduced, and/or
in the event of a decrease in braking torque caused by the further brake system, the action of the brake force booster is increased,
such that the overall braking torque imparted by the overall brake system is substantially constant and wherein the hydraulic accumulator device is operated such that a change in the position of the actuating element caused by a change in the assistance force imparted by the brake force booster is counteracted completely or at least partially compensated, by admission of volume and/or discharge of volume from and/or into the hydraulic brake system.

21. The method as claimed in claim 20, wherein the operating state of the further brake system is represented by a change in the contribution made by the further brake system to the overall braking action, wherein it is provided that:
admission of volume takes place if the contribution made by the further brake system is increased, and/or
discharging of volume takes place if the contribution made by the further brake system is reduced.

22. The method as claimed in claim 20, further comprising a controllable shut-off mechanism configured to shut off at least one hydraulic connection, wherein:
the at least one hydraulic connection between the hydraulic accumulator device and the at least one wheel brake and the master cylinder is shut off by the controllable shut-off mechanism and the discharging of volume and/or the admission of volume of brake fluid into and/or from the hydraulic brake system and the accumulation of the volume of brake fluid is controlled by controlling the shut-off mechanism.

23. The method as claimed in claim 22, wherein:
the hydraulic brake system has a controllable brake force booster and a shut-off mechanism for shutting off a hydraulic connection between the hydraulic accumulator device and the master cylinder and the at least one wheel brake for hydraulically decoupling the wheel brake from the hydraulic accumulator device and the master cylinder, and
the hydraulic accumulator device is charged by controlling the shut-off mechanism and by activating the brake force booster with the shut-off mechanism closed.

24. The method as claimed in claim 20, wherein the pressure level in the hydraulic accumulator unit, at which volume is supplied from the hydraulic accumulator unit to the hydraulic brake system is raised, in particular such that the hydraulic accumulator device discharges the volume automatically,
by the design of the hydraulic accumulator device and/or
by charging the hydraulic accumulator device by the brake force booster and/or
by charging the hydraulic accumulator device by discharging volume from the brake circuit into the hydraulic accumulator device.

25. The method as claimed in claim 20, wherein the hydraulic accumulator device is charged by the brake force booster in driving situations in which the driver is not braking.

26. The method as claimed in claim 20, further comprising a controllable shut-off mechanism configured to shut off at least one hydraulic connection, wherein:
the at least one hydraulic connection between the hydraulic accumulator device and the at least one wheel brake and the master cylinder and the at least one hydraulic connection between the hydraulic accumulator device and a second piston-cylinder unit of an actuating element for the brake system is shut off by the controllable shut-off mechanism and the discharging of volume and/or the admission of volume of brake fluid into and/or from the hydraulic brake system and the accumulation of the volume of brake fluid is controlled by controlling the shut-off mechanism.

27. A hydraulic accumulator device for use in a hydraulic brake system of an overall brake system which, aside from the hydraulic brake system, comprises at least one further non-hydraulic brake system, wherein the hydraulic brake system has a master cylinder and at least one wheel brake, wherein the hydraulic accumulator device is hydraulically connected to an outlet of the master cylinder and to at least one wheel brake and, as a function of the operating state of the further brake system, either admits volume from the hydraulic brake system, holds volume or automatically discharges volume into said hydraulic brake system, wherein the hydraulic brake system has an actuating element for the brake system and the actuating element has a second piston-cylinder unit which is hydraulically connected to the hydraulic accumulator device.

28. The hydraulic accumulator device as claimed in claim 27, further comprising a controllable shut-off mechanism configured to shut off the hydraulic connection between the hydraulic accumulator device and the second piston-cylinder unit, wherein:
the admission of volume from the hydraulic brake system, the accumulation of volume and the discharging of volume into the hydraulic brake system is realized by controlling the shut-off mechanism.

29. The hydraulic accumulator device as claimed in claim 27, wherein the hydraulic accumulator device has a first piston-cylinder unit which includes two pistons and two chambers of different cross-sectional area.
